(19) United States
(12) Patent Application Publication
(10) Pub. No.: US 2008/0266443 A1
(43) Pub. Date: Oct. 30, 2008

(54) Camera Module

(76) Inventor: JUNG YUL LEE, Dobong-gu (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/112,702

(22) Filed: Apr. 30, 2008

(30) Foreign Application Priority Data
Apr. 30, 2007 (KR) 10-2007-0041826

(51) Int. Cl. H04N 5/225

(52) U.S. Cl. 348/344; 348/E05.024

(57) ABSTRACT

Disclosed is a camera module. Embodiments of the camera module include a first lens part, a second lens part, a reflective part, and a light receiving element. The reflective part can be rotated to selectively allow either light transmitted through the first lens part or light transmitted through the second lens part to be incident the light receiving element. The first lens part and the second lens part can be provided having different focal lengths. By using the reflective part to select which lens part's transmitted light is incident the light receiving element, a zoom function can be realized.

### CROSS-REFERENCE TO RELATED APPLICATION

The present application claims the benefit under 35 U.S.C. §119 of Korean Patent Application No. 10-2007-0041826, filed Apr. 30, 2007, which is hereby incorporated by reference in its entirety.

### BACKGROUND

Mobile appliances such as cellular phones equipped with cameras are being introduced that enable a user to take a still image and a moving picture regardless of time and location.

The performance of such cameras have been gradually improved to obtain a high-resolution and high-quality image. Currently, a camera module having an auto-focusing function, a close-up photographing function, and an optical zoom function is being mounted on the mobile appliance.

In order to ensure the performance of the camera module, the camera module is being enlarged.

However, if the camera module is enlarged, mounting the camera module on the mobile appliance is difficult when taking into consideration the size of the mobile appliance. In addition, the mobile appliance can exhibit limitations in performance thereof.

### BRIEF SUMMARY

Embodiments of the present invention provide a camera module capable of performing a zoom function.

According to an embodiment, a camera module can include a first lens part that transmits a light incident from a subject, a second lens part disposed in a traveling direction of the light transmitted through the first lens part, a reflective part disposed between the first lens part and the second lens part to reflect the light that has passed through the first lens part or the second lens part, and a light receiving element which converts the light reflected by the reflective part into an electrical signal.

According to another embodiment, a camera module can include a first lens part that transmits incident light of a subject and has a first optical path, a second lens part that has a second optical path at an angle of 90 degrees with the first optical path, and a reflective part disposed in a position where the first optical path of the first lens part meets with the second optical path of the second lens part. The reflective part can be rotated to reflect the incident light transmitted through the first lens part or to directly transmit the incident light transmitted through the second lens part. The camera module can also include a light receiving element, which converts the incident light reflected by the reflective part into an electrical signal.

### BRIEF DESCRIPTION OF THE DRAWINGS

FIG. 1 is a cross-sectional view showing a camera module having first and second lens parts that are horizontally aligned in opposition to each other according to an embodiment.

FIG. 2 is a cross-sectional view showing a camera module according to an embodiment, where the camera module includes first and second lens parts spaced apart from each other such that their optical paths cross each other at an angle.

### DETAILED DESCRIPTION

Embodiments will now be described with reference to accompanying drawings.

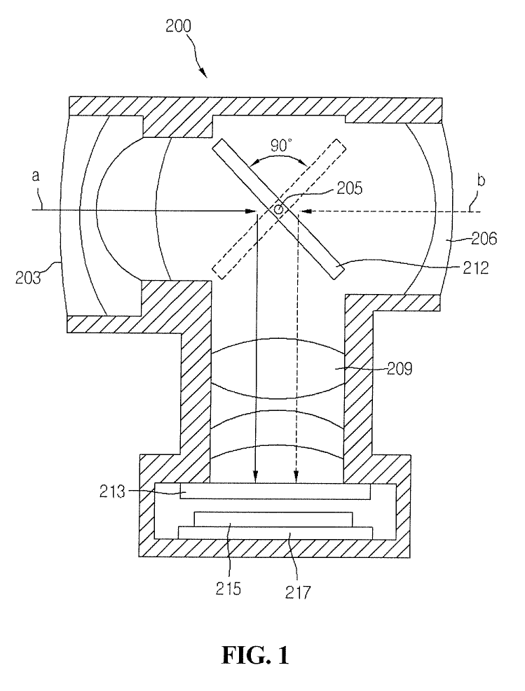

Referring to FIG. 1, a camera module 200 according to a first embodiment can include a first lens part 203, a second lens part 206, a reflective part 212, and light receiving element that converts incident light into an electrical signal. The light receiving element can be an image sensor 215. The camera module 200 can also include a third lens part 209, an infrared ray (IR) filter 213, and a printed circuit board 217.

The first lens part 203 can include at least one lens, and allows light corresponding to image information of a subject to pass therethrough.

The second lens part 206 can include at least one lens.

The second lens part 206 is arranged in opposition to the first lens part 203 in the horizontal direction while being positioned in the traveling direction of incident light (a) having passed through the first lens part 203, such that light corresponding to image information of a subject can pass through the second lens part 206.

In this case, the traveling direction of the light (a) incident onto the first lens part 203 faces the traveling direction of a light (b) incident onto the second lens part 206.

The reflective part 212 can include a mirror, and is interposed between the first and second lens parts 203 and 206.

The reflective part 212 interposed between the first lens part 203 and the second lens part 206 can rotate at an angle of 90 degrees about a rotational axis 205, and reflect the light (a) incident onto the first lens part 203 or the light (b) incident onto the second lens part 206 at an angle of 90 degrees according to the position of the reflective part 212.

The reflective part 212 can be manually rotated from an outer portion of the camera 10 module. In an embodiment, the reflective part 212 can be rotated by employing an actuator for the rotational axis 205 of the reflective part 212. In certain embodiments, the actuator can include a motor or a magnet and coil.

In other words, the rotational angle of the reflective part 212 can be controlled to select the incident light (a) having passed through the first lens part 203 or the incident light (b) having passed through the second lens part 206.

The first lens part 203 can have a structure different from that of the second lens part 206, so that the lens parts 203 and 206 have different focal lengths.

In one embodiment, the first lens part 203 can have a structure different from that of the second lens part 206 by providing the first lens part 203 and the second lens part 206 with different curvature radiuses or different numbers of lenses. Accordingly, the focal lengths of the first lens part 203 and the second lens part 206 can be different from each other.

In other words, the first lens part 203 or the second lens part 206 can be selected by the reflection direction of the reflective part 212 to realize a zoom function of the camera module.

This means that it is possible to realize a camera module that is installed in a lens barrel and performs a zoom function without a motor for the zoom function. Instead, the different focal lengths required by the zoom function can be achieved by selecting either the first lens part 203 having a first focal length or the second lens part 206 having a second focal length.

The third lens part 209 can be positioned in the traveling direction of light reflected by the reflective part 212 such that the reflected light passes through the third lens part 209. The third lens part 209 can be provided between the reflective part 212 and the image sensor 215.

The IR filter 213 can be provided between the third lens part 209 and the image sensor 215. The image sensor 215, which is a light receiving element, can receive light having passed through the third lens part 209 to convert an optical signal into an electrical signal.

The printed circuit board 217 can be provided under the image sensor 215. The printed circuit board 217 can transmit a signal from the image sensor 215 to an exterior.

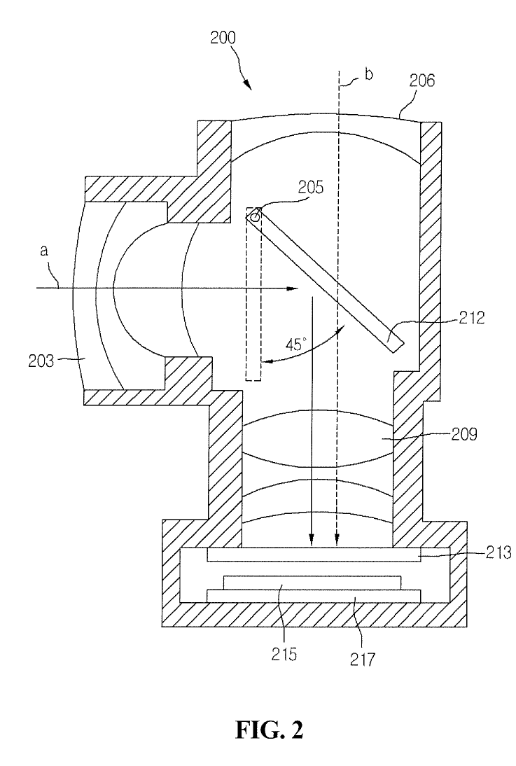

Referring to FIG. 2, a camera module 200 according to a second embodiment can include a first lens part 203, a second lens part 206, a reflective part 212, and a light receiving element that converts incident light into an electrical signal. The light receiving element can be an image sensor 215. The cameral module 200 can also include a third lens part 209, an infrared ray (IR) filter 213, and a printed circuit board 217.

The first lens part 203 can include at least one lens, and allows light corresponding to image information of a subject to pass therethrough.

The second lens part 206 can include at least one lens. The second lens part 206 can be provided at an angle to an optical path (a) of the first lens part 203 while being spaced apart from the first lens part 203. In a specific embodiment, the second lens part 206 is provided perpendicularly to the optical pat (a) of the first lens part 203.

In other words, incident light (a) having passed through the first lens part 203 can be perpendicular to incident light (b) having passed through the second lens part 206.

The reflective part 212 can include a mirror, and is provided at a position where the incident light (a) having passed through the first lens part 203 meets with the incident light (b) having passed through the second lens part 206.

In this case, the reflective part 212 can rotate to reflect the incident light (a) having passed through the first lens part 203 at 90 degrees, or to allow direct transmission of the incident light (b) having passed through the second lens part 206.

According to a specific implementation of the second embodiment, the reflective part 212 can rotate at an angle of 45 degrees about a rotational shaft 205.

The reflective part 212 can be manually rotated from an outer portion of the camera module. In an embodiment, the reflective part 212 can be rotated by employing an actuator for the rotational axis 205 of the reflective part 212. In certain embodiments, the actuator can include a motor or a magnet and a coil.

In other words, the rotational angle of the reflective part 212 can be controlled to select the incident light (a) having passed through the first lens part 203 or the incident light (b) having passed through the second lens part 206.

If the incident light (a) having passed through the first lens part 203 is used, the reflective part 212 can be used to shield the incident light (b) having passed through the second lens part 203. If the incident light (b) having passed through the second lens part 206 is used, the reflective part 212 can be used to shield the incident light (a) having passed through the first lens part 206.

The first lens part 203 can have a structure different from that of the second lens part 206 by providing the first lens part 203 and the second lens part 206 with different curvature radiuses or different numbers of lenses. Accordingly, the focal lengths of the first lens part 203 and the second lens part 206 can be different from each other.

In other words, the first lens part 203 or the second lens part 206 can be selected by the reflection direction of the reflective part 212 to realize a zoom function of the camera module.

This means that it is possible to realize a camera module that is installed in a lens barrel and performs a zoom function without a motor for the zoom function. Instead, the different focal lengths required by the zoom function can be achieved by selecting either the first lens part 203 having a first focal length or the second lens part 206 having a second focal length.

The third lens part 209 can be positioned in the traveling direction of light reflected by the reflective part 212 such that the reflected light passes through the third lens part 209. The third lens part 209 can be provided between the reflective part 212 and the image sensor 215.

The IR filter 213 can be provided between the third lens part 209 and the image sensor 215. The image sensor 215, which is a light receiving element, can receive light having passed through the third lens part 209 to convert an optical signal into an electrical signal.

The printed circuit board 217 can be provided under the image sensor 215. The printed circuit board 217 can transmit a signal from the image sensor 215 to an exterior.

As described above, according to embodiments of the present invention, it is possible to realize a camera module having a zoom function by selectively using at least two lens parts having different focal lengths.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A camera module comprising:
a first lens part for transmitting light incident from a first direction;
a second lens part for transmitting light incident from a second direction, the second lens part being disposed in a traveling direction of the light transmitted through the first lens part;
a reflective part disposed between the first lens part and the second lens part to selectively reflect the light passing through the first lens part and the second lens part; and
a light receiving element that converts the light reflected by the reflective part into an electrical signal.

2. The camera module according to claim 1, further comprising a third lens part disposed in a traveling direction of the light reflected by the reflective part, wherein the third lens part is disposed between the reflective part and the light emitting element.

3. The camera module according to claim 1, wherein the reflective part includes a mirror.

4. The camera module according to claim 1, wherein the reflective part selectively reflects the light passing through the first lens part and the second lens part by being rotatable, wherein the reflective part reflects the light transmitted through one of the first lens part and the second lens part toward the light receiving element.

5. The camera module according to claim 1, wherein the reflective part rotates at an angle of 90 degrees.

6. The camera module according to claim 1, wherein the first lens part has a focal length different from a focal length of the second lens part.

7. The camera module according to claim 1, wherein the first lens part comprises at least one lens, and wherein the second lens part comprises at least one lens.

8. A camera module comprising:
a first lens part for transmitting incident light in a first optical path;
a second lens part for transmitting incident light in a second optical path, wherein the second optical path is at an angle from the first optical path;
a reflective part disposed in a position where the first optical path of the first lens part meets with the second optical path of the second lens part, wherein the reflective part rotates to reflect the incident light transmitted through the first lens part or allow direct transmission of the incident light transmitted through the second lens part; and
a light receiving element that converts the incident light reflected by the reflective part into an electrical signal.

9. The camera module according to claim 8, further comprising a third lens part disposed between the reflective part and the light receiving element.

10. The camera module according to claim 8, wherein the reflective part includes a mirror.

11. The camera module according to claim 8, wherein the reflective part shields the incident light having been transmitted through the second lens part when the incident light having been transmitted through the first lens part is reflected at an angle of 90 degrees and input into the light receiving element, and shields the incident light having been transmitted through the first lens part when the incident light having been transmitted through the second lens part is directly incident into the light receiving element.

12. The camera module according to claim 8, wherein the reflective part rotates at an angle of 45 degrees.

13. The camera module according to claim 8, wherein the first lens part has a focal length different from a focal length of the second lens part.

14. The camera module according to claim 8, wherein the angle of the second optical path from the first optical path is 90 degrees.

15. A camera module comprising:
a first optical path, which guides light in a first direction;
a second optical path, which the light in a second direction;
a reflective part disposed in a position where the first optical path crosses the second optical path; and
a third optical path guiding the light incident through the first optical path or the second optical path and reflected by the reflective part toward the light receiving element.

16. The camera module according to claim 15, wherein the reflective part is disposed in a position wherein the first optical path meets with the second optical path.

17. The camera module according to claim 16, wherein the reflective part rotates to selectively reflect or shield the light incident from the first optical path or the second optical path, such that the light is incident onto the light receiving element through the third optical path.

18. The camera module according to claim 16, wherein the first optical path passes through a first lens part and the second optical path passes through a second lens part, and wherein the first lens part has a focal length different from a focal length of the second lens part.

19. The camera module according to claim 15, wherein the reflective part is disposed at a position where the first optical path perpendicularly crosses the second optical path.

20. The camera module according to claim 19, wherein the reflective part rotates to shield the light from the second optical path when the light from the first optical path is reflected by the reflective part toward the light receiving element through the third optical path, and
wherein the reflective part rotates to shield the light from the first light path when the light from the second optical path is allowed to be directly incident into the light emitting element.
